(19) United States
(12) Patent Application Publication
(10) Pub. No.: US 2008/0255887 A1
(43) Pub. Date: Oct. 16, 2008

(54) Method and system for processing an insurance claim for a damaged vehicle

(75) Inventor: Robert Gruter, Sauerlach (DE)

Correspondence Address: BUCHANAN, INGERSOLL & ROONEY PC, POST OFFICE BOX 1404, ALEXANDRIA, VA, 22313-1404, US

(73) Assignee: AUTOonline GmbH Informationssysteme, Neuss (DE)

(21) Appl. No.: 11/783,499

(22) Filed: Apr. 10, 2007

(51) Int. Cl. G06Q 40/00

(52) U.S. Cl. 705/4

(57) ABSTRACT

Disclosed is a system and method for processing an insurance claim by an insurance company for an insured's damaged vehicle The method includes acquiring information regarding the damaged vehicle, and the geographical location of the damaged vehicle. An auction is conducted based on the acquired information regarding the damaged vehicle to sell, for a satisfactory bid, the damaged vehicle from the insured to a bidder, wherein the insured is the owner of the damaged vehicle. A bidder, who submits the satisfactory bid, is informed of the location of the damaged vehicle, where he directly picks up the vehicle. The title of the vehicle is transferred directly from the insured to the bidder or from the insured to the insurance to the bidder during or after the auction.

### FIELD

A method and system for processing an insurance claim for a damaged vehicle, such as an automobile, a motorcycle, a sailboat, a motor boat, or the like.

### BACKGROUND

According to the website “car-accidents.com”, there were approximately 6.42 million motor vehicle accidents in the United States in 2005, at a cost of more than 230 billion dollars. When an insurance claim is made following an accident, an adjuster typically will be assigned to view the damaged automobile and assess the cost to repair the damage, thus restoring the vehicle to its pre-accident condition. Damaged vehicles are considered those that have scratches, dents, excessive wear (e.g. such as high mileage for the age of the vehicle), collision damage, flood damage, fire damage, or any damage that would possibly exceed the value of the vehicle. The cost of various damaged components of the vehicle can be estimated to determine the cost of their individual repair cost(s). The total dollar value (i.e., cost) for each damaged component and estimated labor is summed to arrive at an overall estimated cost to repair the vehicle. This cost can be compared to the vehicle's replacement value using common industry valuation methods such as the NADA™ guide, Kelly Blue Book™, and the like to determine whether it is more economical to repair the vehicle or whether the vehicle is a total loss. If repair costs are less than a certain percentage, e.g. eighty percent (the percentage can vary by state regulation and insurance practices) of the replacement value, the vehicle can be repaired.

Even if the vehicle is determined to be a total loss, the vehicle likely has some residual value that can be recovered by “salvaging” the vehicle by removing the non-damaged parts and selling them for some value. Once these parts are sold, the remaining parts or recyclable materials are sold as scrap. Less damaged cars usually get sold to countries and regions where labor rates are lower (e.g., Mexico or Eastern Europe) and where repair is therefore more economically feasible. If known, the residual value can be used by an insurance company to predict how much the damaged vehicle will sell for in an auction or other type of sale. If the residual value is predicted to be high (relative to the replacement value); the threshold (relative to the replacement value) for repairing damage is economically reasonable decreases. For example, if the residual value is predicted to be 40% of replacement value it is more lucrative for an insurance company to salvage the vehicle when damages exceed 60% of replacement value. The exact knowledge of the residual value would allow to enhance the salvage or repair decision, and to save unnecessary repair costs. The additional cost of towing the vehicle from its initial location to a secondary storage area managed by the insurance company, or to an auction company, and including any costs incurred up to and during the auction, the sale and completion of the final transfer of the vehicle title are usually taken into account as well.

The terms “salvage” or “salvaged vehicle” are commonly defined in state regulations, and the definition can vary from State to State. In addition, insurance companies may further narrow its definition of a salvage or salvaged vehicle based on historical data that it has accumulated. A salvage vehicle can be a vehicle that, by reason of its condition or circumstance, is declared to be non-repairable by an insurance company, or the vehicle's owner, and is transferred to a salvage reseller or salvage dismantler, who issues a certificate of salvage.

Typically, each vehicle in the United States is “titled” or registered to a person or organization who is responsible for, or who owns, the vehicle. During a sale (i.e., transfer of ownership) of a vehicle, the title to the vehicle transfers from the present owner to the buyer in order for the sale (transfer) to be completed properly and legally. The title is a legal document that identifies the vehicle and the owner of the vehicle. The title will often be marked or stamped to denote its new designation of being previously declared a total loss. Often the title will contain a phrase such as SALVAGED VEHICLE. Each State has its own unique regulations regarding the proper titling or registration of salvage vehicles. The process required to transfer titles is handled in the United States on a State by State basis. Some States will allow quick electronic title transfers to be performed. More commonly, a physical paper transfer is required, which can often take four weeks or longer.

When a vehicle is recovered after theft or damaged, such as in an accident or from vandalism, and the vehicle is non-operational or unmovable, it usually will be removed to a location decided upon by the owner of the vehicle, or law enforcement official. Typically, the vehicle is removed by a tow truck or other similar vehicle hauling machine. The location to which the vehicle is towed may be a location specified by the vehicle owner, a collision repair facility, a towing company storage yard, an insurance company holding facility, or a police impound center, if charges are pending. A representative from the insurance company, such as an automobile claims adjuster/appraiser or a person at a collision repair facility, will inspect the damaged vehicle. If the cost to repair the vehicle is determined to be too high or is technically infeasible (i.e., damaged beyond repair, destroyed by fire, or similar damage), the insurance company can decide to settle with, or pay, the insured the value of the car before the damage occurred. In these instances, the insurance company can pay the local replacement value of the car, which is known in industry terms as an “Absolute Cash Value” or ACV to the insured. The value paid to the insured is reduced by the estimated salvage value (the estimated value the damaged vehicle would achieve at an auction). When the insurance company settles (i.e., the insured does not want to keep the vehicle), the vehicle can be towed a second time to a special holding area of an auction company, such as Co-part, Auto Insurance Auctions, and the like, for auction or salvage. Title is transferred to the insurance company, which is also an indicator to future owners or buyers of the vehicle that the vehicle was significantly damaged at some time.

This step ensures that future buyers can recognize that the vehicle was damaged to the point that repair was uneconomical or infeasible. After the title has been transferred to the insurance company, the auction company sells the vehicle on behalf of the insurance company to the highest bidder during the subsequent auction process.

The vehicle auction process may be a “live” auction that bidders participate in person or one hosted via the Internet that may include posting of digital images of the damaged vehicle on a website that allows the submission of on-line bids.

If the insured decides to keep or “retain” the damaged vehicle, the actual lost cost to the insurance company can be reduced by the estimated salvage value (the estimated value the wreck would sell for in an auction).

### SUMMARY

Disclosed is a method for processing an insurance claim by an insurance company for an insured's damaged vehicle which has been stored at a location. The method includes acquiring information regarding the damaged vehicle, and the geographical location of the damaged vehicle. An auction is conducted based on the acquired information regarding the damaged vehicle to sell, for a satisfactory bid, the damaged vehicle from the insured to a bidder, where the insured is the owner of the damaged vehicle. A bidder, who submits the satisfactory bid, is informed of the location of the damaged vehicle. The title of the vehicle is either transferred directly from the insured to the bidder, or is transferred from the insured to the insurance to the bidder. The title transfer can be completed during or after the auction. Optionally, vehicle configuration details can be looked up in a database using a vehicle identification number.

Disclosed is a method for processing an insurance claim for a damaged vehicle, the method including transferring data from a vehicle damage estimating system or entering the data manually into an insurance company's claim handling system and to a vehicle auction system. A salvage value is calculated for the damaged vehicle, for a given geographical location, using a database of historic salvage values. A local retail value is provided, for the geographical location, of the damaged vehicle and information contained in a database to an insurance company. A comparison is made by the insurance company of portions of the transferred data to a threshold value that is based on the calculated salvage value and the local retail value for the geographical location of the damaged vehicle. An auction of the vehicle is conducted based on results of the comparison, and title of the damaged vehicle is directly transferred from the insured to a bidder in the auction.

Disclosed is a system for processing a vehicle insurance claim including a means for providing data from a vehicle damage estimating system to an insurance claim handling system and to a first vehicle reseller, wherein the insurance claim handling system is associated with a vehicle insurance company. A means for calculating, by the first vehicle reseller, calculates a salvage value for the insured's damaged vehicle. A market value is calculated based on the transferred data, resale market in insured's local area, and vehicle optional equipment installed on the damaged vehicle. Portions of the transferred data are compared to a threshold value based on the calculated salvage value and the absolute cash value, wherein based on the result of the comparison, a second vehicle reseller offers the damaged vehicle for resale to a group of potential buyers by a means for comparing. Title of the damaged vehicle is directly transferred to one of a group of bidders by a means to transfer title.

### BRIEF DESCRIPTION OF THE DRAWING FIGURES

An exemplary method and system will be described in greater detail with reference to the attached drawings, in which:

FIG. 1 is a flow chart of an exemplary method as described herein for processing of an insurance claim for a damaged vehicle;

FIG. 2 is a flow chart of an exemplary method as described herein for processing a salvage claim for a damaged vehicle; and

FIG. 3 illustrates an exemplary system as described herein for implementing either or both of the processes shown in FIGS. 1 and 2.

### DETAILED DESCRIPTION

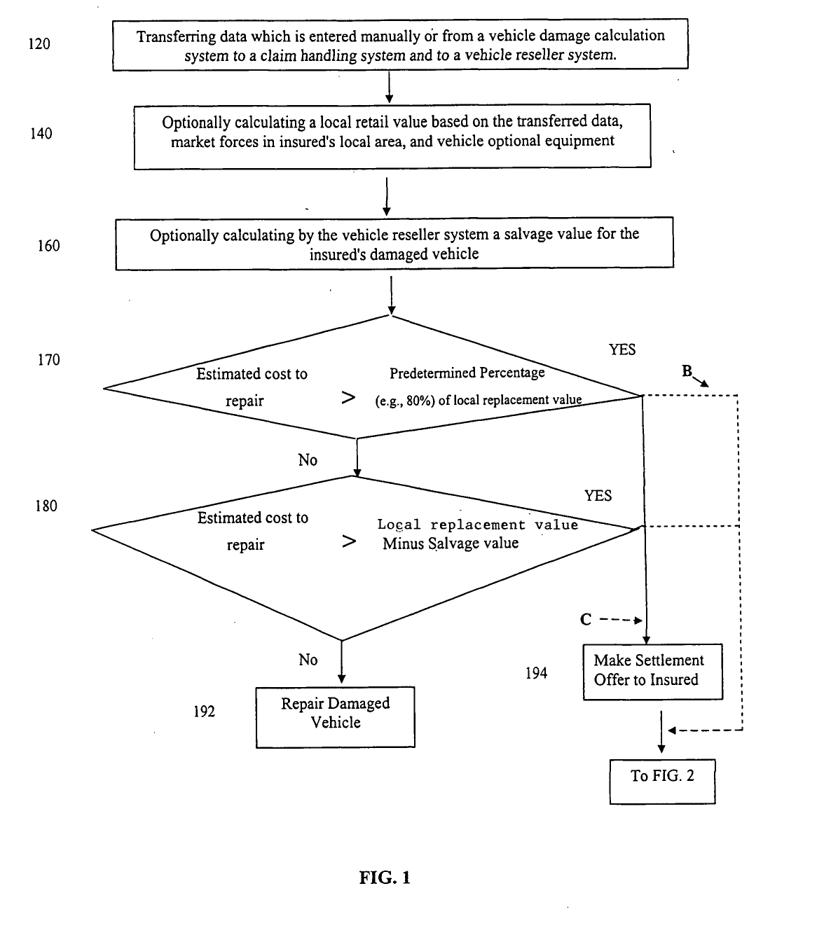

FIG. 1 illustrates an exemplary method for processing an insurance claim for a damaged vehicle by an insured owner, such as an insured person or entity.

In step 120, data is transferred from a vehicle damage estimating system, such as those provided by Audatex, CCC or Mitchell International, to a claim handling system and a vehicle marketing system. Alternatively, the data can be manually entered into the claim handling system, via a keyboard or the like connected to a computer system having access to the claim handling system. The claim handling system can be associated with the vehicle owner's insurance company. An insurance company can outsource the function performed by a claim handling system to a third party, or the insurance company can perform the function themselves. Thereby, the insurance company acquires information regarding the damaged vehicle, and the geographical location of the damaged vehicle.

The vehicle damage estimate system software used by automobile or vehicle repair facilities to document the damage to the vehicle can be supported by an insurance company that insures vehicles. For example, a vehicle is owned by person A and insured by company XYZ. Person A is involved in an accident, and the vehicle is taken to an inspection site, such as a repair facility that would also make repairs to the damaged vehicle. Person A decides to file an insurance claim with insurance company XYZ for the cost of repairing the vehicle to its pre-accident condition. Personnel at the repair facility or associated with the insurance company XYZ can use a software program or a computer application associated with the insurance company XYZ to input data into a vehicle damage estimation system, which is used to estimate the cost of repairing the vehicle. Examples of a vehicle estimation system include those provided by Audatex, CCC, Mitchell International and the like. The personnel at the repair facility can identify and record data regarding the following: areas of the vehicle or systems that were damaged or do not function properly; the vehicle's configuration (including optional equipment installed on or in the vehicle, such as moon roof, rear spoiler, leather seats and the like); obtain images, 3D images and/or video of the damaged vehicle; an itemized list of repairs that need to be performed; and other data, such as vehicle identification number (VIN). The recorded information can vary depending on the needs of the repair facility, state requirements, or insurance company.

Referring to FIG. 1, the data mentioned with respect to step 120, is transferred to a claim handling system of or associated with the insurance company XYZ and/or a vehicle marketing (e.g. reseller) system. In some cases, the title to the vehicle will be transferred to the insurance company before the vehicle can be sold to another party. In those cases, the vehicle reseller system would transfer title to the insurance company prior to any sale of the vehicle to a third party.

Using the data provided by the vehicle damage estimation system, the insurance company, as an option, calculates a local retail cost (i.e., the replacement cost in the insured's geographical region), the salvage resale market value in the insured's local geographical area (i.e., local replacement cost) for that type of vehicle, and the additional value of the optional equipment installed on the damaged vehicle (step 140). The local replacement cost can also be provided by a damage appraiser using the above factors as well as industry databases such as those provided by Kelley Blue Book™, NADA™, Mitchell™, CCC™ or Audatex™ or any combination information sources. More or less information can be entered to more or less accurately determine the local replacement or ACV.

Optionally, a first vehicle reseller system can automatically look up vehicle data based on the Vehicle Identification Number (VIN). Or as another alternative, a first vehicle reseller system can estimate a salvage value for the insured's damaged vehicle also based on historic data of vehicles with similar characteristics auctioned in the past and the data transferred of the current vehicle, in step 120, from the vehicle damage estimation system used by the automobile repair facility (step 160). A decision, at step 170, is made based on whether the estimated cost of repair is greater than a predetermined percentage of the vehicle's replacement cost. If the estimated cost to repair the vehicle is greater than a predetermined percentage (e.g. 80% or higher or lower) of the vehicle's local replacement cost, the insurance company can decide to make a settlement offer to the insured (step 194), if accepted by the insured the insurance company can begin to salvage the vehicle. The predetermined percentage can vary depending upon the local area resale market, state statutes, insurance company policies and/or other factors.

If, at step 170, the estimated cost of repair is not greater than the predetermined percentage, another decision can be made regarding the disposition of the damaged vehicle. At step 180, the insurance company can decide whether the estimated cost of repair is greater than the replacement cost less the salvage value calculated by the vehicle reseller system. If the estimated cost to repair is greater than the replacement value (local retail value) minus the salvage value, the insurance company decides the vehicle is a total loss, and makes a settlement offer to the insured (step 194). If the estimated cost to repair is less than the replacement cost less the salvage value, the insurance company can decide the damaged vehicle can be repaired (step 192).

For example, the cost to repair the vehicle may be 70% of the value of the vehicle prior to it being damaged (which equals 100%), but the salvage value of the vehicle may be 40% of the value of the vehicle prior to it being damaged. The insurance company can offer to settle with the insured for the 60% (100%−40%) of the value of the vehicle prior to it being damaged, sell the vehicle for the salvage value, and save 10% of the value of the vehicle prior to being damaged. The salvage value can be based on historical data of previously sold vehicles including the type of vehicle, type of damage geographical location, vehicle condition and other suitable factors. Of course, all or fewer of the described decision methods can be used to make the determination to settle, the order of the decisions can be changed or more or less decisions made, and the decision thresholds can be different.

FIG. 1 also illustrates an alternative decision path B that bypasses step 194 in which a settlement offer is made to the insured. Alternative decision path B allows the insurance company to enter the auction process to see if a bidder is willing to submit a bid that is greater than the estimated cost to repair the damaged vehicle.

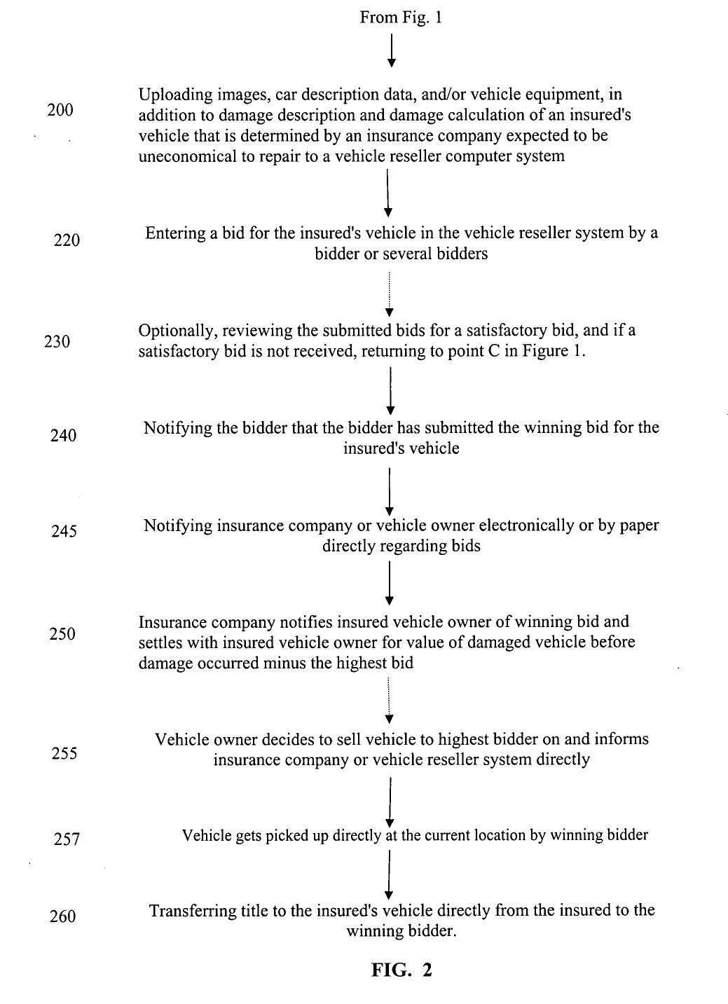

FIG. 2 illustrates an exemplary method for disposing of a salvage vehicle resulting from an insurance claim. The illustrated exemplary method can be implemented after the process described above with respect to FIG. 1, or alone. For ease of understanding, the exemplary method illustrated in FIG. 2 is described in combination with FIG. 1.

When it is determined that the vehicle is unrepairable, and a settlement offer is made to the insured, the disposition of the damaged vehicle can be addressed. The insurance company need not take possession of or title to the damaged vehicle. This can be performed through a salvage sale process or through the disposal of the damaged vehicle in some other manner. By not taking possession or title to the vehicle, the insurance company can avoid additional administrative costs.

Referring to FIG. 2, step 200 involves uploading images and/or a textual description, such as vehicle color, age and mileage of an insured's damaged vehicle to a vehicle reseller computer system. The description can also include a description of equipment (e.g. air conditioner, number of air bags, seating type, and the like), data retrieved from a database using the Vehicle Identification Number (VIN), a damage description and/or a cost calculation of the amount of damage. The damaged vehicle can be photographed either using a digital or analog, still or video camera. The digital images or scanned photographs of the damaged vehicle are uploaded to a vehicle reseller's computer system or server. The vehicle reseller computer system can be accessible to authorized members of the public, vehicle resellers, automotive dealers, scrape metal dealers, and exporters, among other or fewer persons. Collectively, these persons can be called bidders.

When one of the bidders wishes to enter or submit a bid to purchase the insured's damaged vehicle, they access the computer system of the vehicle reseller via, for example, the Internet (step 220). The bidder enters a bid based on the photographs and/or any written description of the damage to the vehicle. As an example, the images may show a vehicle that is otherwise undamaged but may have been involved in a flood, such as that resulting from hurricane Katrina. In such a case, the damage would not be evident in the photographs, but would be apparent from any narrative associated with the photographs. The bidder can be charged a fee for submitting a bid.

A vehicle marketer or reseller can determine an amount of time that the images of the damaged vehicle will be posted on the computer system, and the amount of a satisfactory or qualifying bid. A qualifying, or satisfactory, bid would, for example, be a bid that meets a predetermined minimum value for which the seller (e.g., insurance company, vehicle reseller, the insured, or other party) is willing to sell the vehicle. This predetermined minimum value can be set by an insurance company, by some other entity managing the sale of the vehicle, be based on historical data that may cause the predetermined minimum value to fluctuate, other factors, or any combination of factors. The historical data can be maintained by the vehicle reseller or some other entity, for example, in a database. After being posted the predetermined amount of time on the vehicle reseller's computer system, the submitted bids are reviewed.

Step 230 is an optional step that is taken when alternative decision path B is taken in FIG. 1. In optional step 230, the submitted bids are reviewed to determine whether a qualifying or satisfactory bid has been received. If a qualifying or satisfactory bid has not been received, the insurance company can decide to repair the vehicle and return to the process illustrated in FIG. 1 at point C.

If at least one qualifying or satisfactory bid has been received bid, a winning bid (e.g., highest bid) for the damaged vehicle will be determined. The winning bidder will be notified that they have submitted the winning bid for the damaged vehicle (step 240).

At step 245, the insurance company, or alternatively, the insured vehicle owner, can also be provided with the submitted bids. The notification can be done electronically or by paper, e.g., facsimile or mail.

If not already notified, the insurance company notifies the vehicle owner of the highest bid and settles with the vehicle owner for the value of the damaged vehicle before the accident minus the winning bid (step 250).

Alternatively, the vehicle owner may decide on their own to sell the vehicle to the highest bidder, and will inform the insurance company, or vehicle reseller directly, for instance, through the Internet (step 255). At step 257, the vehicle is picked up directly at its current location by the winning bidder.

The title of the damaged vehicle can be transferred directly from the insured to the insurance company or purchaser (step 260). The procedural steps taken to transfer title can depend upon which State the vehicle was originally titled in, or in which State the sale of the damaged vehicle takes place, or other factors. The status of the title transfer process can be displayed in the first vehicle reseller system or another system that maintains vehicle title status.

In an exemplary method, the title of the vehicle is not transferred to the insurance company, thereby minimizing the fees to the insurance company associated with the title transfer, storage of the vehicle. Instead, the title to the vehicle can be transferred directly to the winning bidder. The title can have an indication of being a salvaged vehicle or the like so future owners will have notice that the vehicle was damaged at one time. The winning bidder is informed by the insured, insurance company, or the first vehicle reseller system of the vehicle location, so the bidder can pick up the vehicle. Bidder directly picks up the vehicle at the vehicle location. The insurance company saves extra time and costs for towing and storing the vehicle on an auction yard through this direct pick-up.

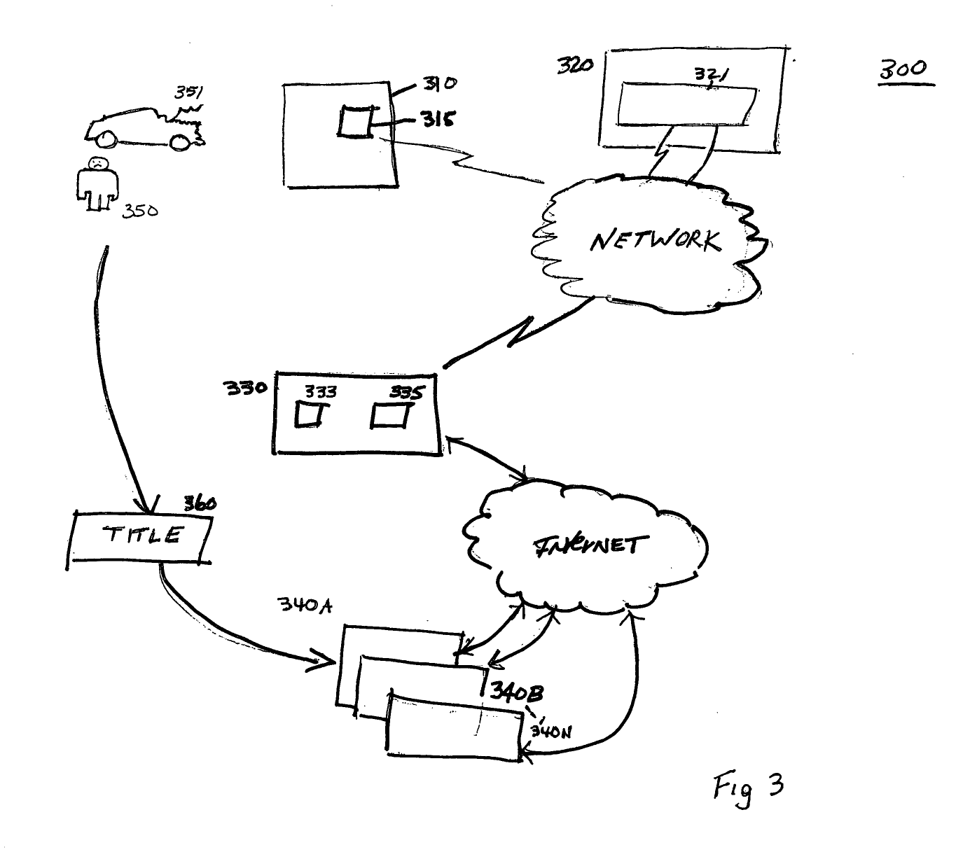

FIG. 3 illustrates an exemplary system for implementing the above described processes. System 300 can include a repair facility 310 having a repair facility computer 315. A damaged vehicle 351 has been brought to the repair facility for a determination of whether the vehicle 351 should be repaired or salvaged. Repair facility computer 315 can use appraisal software programs, which are presently available in the commercial market, to assist the repair facility 310 in making the estimate of the cost to repair the vehicle 351. Alternatively, repair facility 310 personnel can manually enter estimates of the cost to repair the vehicle in repair facility computer 315. Additional information regarding the damaged vehicle 351, such as optional equipment, e.g. sunroof, high-end stereo equipment and the like, the type of vehicle, VIN, and the extent of damage to the exterior, interior, and operating systems of the vehicle, such as electrical, safety or mechanical, can also be documented, and a cost to repair the damaged components is determined.

After completing an estimate of the cost to repair the damaged vehicle 351, the repair facility 310 can forward, via repair facility computer 315, the estimate of the cost to repair to a claims handling system 321 of the insurance company 320 via a secure connection, such a dedicated network or secure Internet connection. Alternatively, the estimate information can be communicated to insurance company 320 and manually entered into the claims handling system via a keyboard that has direct access to the claims handling system. The damaged vehicle 351 can remain at its initial geographical storage location throughout the process.

The repair facility 310 can also forward the estimate of the cost to repair and other information to a vehicle reseller 330, who will use the estimate and other information to calculate a salvage value using software 333 hosted on a computer. In addition, to the estimate of the cost to repair, the repair facility 310 can also forward via repair facility computer 315, images of the damaged vehicle 351, so the vehicle marketer or reseller 330 can post the images on a website 335 for soliciting bids from persons who access the website 335. Alternatively, the estimate of the cost to repair and other information can be forwarded by the insurance company 320 to the vehicle reseller 330. Of course, all communications can be made over a common network, such as the Internet.

An authorized bidder from bidders 340A-N can access the vehicle reseller website 335 via the Internet or dedicated network connection or other suitable interface, and post a bid to purchase the damaged vehicle 351. The bid can be a monetary amount that the bidder is willing to pay for the damaged vehicle. After a predetermined time period, a winning bidder from bidders 340A-340N can be notified that they have submitted the winning bid (e.g., highest bid). The winning bidder provides payment to the vehicle reseller 330. After payment is received or, optionally, verified, the title 360 can be transferred directly from the present vehicle owner 350 to the winning bidder. The winning bidder accepts delivery of the damaged vehicle 351 from its initial storage site. Additional costs to the insurance company associated with transferring title to the insurance company and any storage costs can thereby be avoided.

The vehicle reseller can use software 333 to determine a salvage value for the damaged vehicle 351. The determination of a salvage value for damaged vehicles can be based on historical data such as the model year, manufacturer, model and the parts of the vehicle that are still usable or may be removed from the vehicle for additional use, and demand for the type of vehicle in areas where the vehicle reseller operates. For instance, a pickup truck may have more value in a developing foreign country than in the United States or Europe.

The presently described embodiments can also be applicable to fleet vehicle operators who wish to dispose of used vehicles from the fleet of vehicles. The described auction system can use historical data obtained from prior sales of the particular type of fleet vehicle to place an expected value on each fleet vehicle to be disposed.

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. A method for processing an insurance claim with an insurance company for an insured's damaged vehicle which has been stored at a location, the method comprising:
acquiring information regarding the damaged vehicle, and the geographical location of the damaged vehicle;
optionally automatically looking up vehicle configuration details in a database using a vehicle identification number;
conducting an auction based on the acquired information regarding the damaged vehicle to sell, for a satisfactory bid, the damaged vehicle from the insured to a bidder or from the insured to the insurance to the bidder, wherein the insured is the owner of the damaged vehicle;
informing a bidder, who submits the satisfactory bid, of the location of the damaged vehicle; and
transferring title of the vehicle directly from the insured to the bidder;
displaying the status of the title to a system;
exchanging automatically data with the bidder to automatically process the title transfer during or after the auction; and
picking up the vehicle, by the bidder, at the geographical location.

2. The method of claim 1, comprising:
removing the damaged car from accident scene to the geographical location of an inspection site.

3. The method of claim 1, wherein the acquired information is obtained from at least one of an insurance claim management system, damage calculation system, or a car repair expert.

4. The method of claim 2, wherein the geographical location of the damaged vehicle is an inspection site.

5. The method of claim 1, wherein the damaged vehicle is insured or owned by a fleet vehicle operator or company that owns a fleet of vehicles.

6. The method of claim 1, wherein the damaged vehicle is not moved from the geographical location prior to sale.

7. The method of claim 1, comprising:
repairing the damaged vehicle, if a satisfactory bid is not received during the auction.

8. The method of claim 1, wherein the bidder is the insurance company.

9. A method for processing an insurance claim for a damaged vehicle, the method comprising:
transferring data from a vehicle damage estimating system or entering the data manually into an insurance company's claim handling system and to a vehicle auction system;
calculating a salvage value for the damaged vehicle, for a given geographical location, using a database of historic salvage values;
providing a local retail value, for the geographical location, of the damaged vehicle and information contained in a database to an insurance company;
comparing, by the insurance company, portions of the transferred data to a threshold value that is based on the calculated salvage value and the local retail value for the geographical location of the damaged vehicle;
conducting an auction of the vehicle based on results of the comparison; and
directly transferring title of the damaged vehicle from the insured to a bidder in the auction.

10. The method of claim 9, wherein the database of historical values comprises values of vehicles with similar vehicle type, mileage, damage and/or age.

11. A system for processing a vehicle insurance claim comprising:
a means for providing data from a vehicle damage estimating system to an insurance claim handling system and to a first vehicle reseller, wherein the insurance claim handling system is associated with a vehicle insurance company;
a means for calculating, by the first vehicle reseller, a salvage value for the insured's damaged vehicle;
a means for calculating a market value based on the transferred data, resale market in insured's local area, and vehicle optional equipment installed on the damaged vehicle;
a means for comparing portions of the transferred data are compared to a threshold value based on the calculated salvage value and the absolute cash value, wherein based on the result of the comparison, a second vehicle reseller offers the damaged vehicle for resale to a group of potential buyers; and
a means for directly transferring title of the damaged vehicle to a bidder.

12. The system of claim 11, wherein the means for providing data is a means for manually entering data or a means for electronically transferring data.
